(19) United States
(12) Patent Application Publication
(10) Pub. No.: US 2005/0081766 A1
(43) Pub. Date: Apr. 21, 2005

(54) Feeder for high moisture content coal

(76) Inventor: Malcolm John Mclntosh, Donvale (AU)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/484,297

(22) PCT Filed: Jul. 8, 2002
(86) PCT No.: PCT/AU02/00905

(30) Foreign Application Priority Data
Jul. 20, 2001 (AU) PR 6505

(51) Int. Cl. B02B 3/06

(52) U.S. Cl. 110/286

(57) ABSTRACT

A feeder for high moisture content carbonaceous material, especially lignite, includes a housing (1) having an inlet (2) for introducing the carbonaceous material to the housing (1). The housing (1) has one or more converging sections (12a-12e) that are preferably of frusto-conical shape. A shaft (6) extends through the housing. Auger sections (8) define screw flights for transporting the carbonaceous material through the housing. Auger sections (8) do not extend through the converging sections (12a-12e). At least one radially extending paddle extends from the shaft in each converging section. The feeder can be used to feed carbonaceous material to a high pressure environment, such as a boiler.

This invention relates to a device for feeding solid material having a high moisture content into a pressure vessel. The invention is suited to feeding high moisture content porous material which can be formed into a paste under shear loading. The invention is particularly suited to feeding high moisture content carbonaceous fuel such as coal into a pressure vessel such as a pressurized combustion vessel.

There are many countries with large deposits of low rank coals such as lignite. Lignite and other low rank coals are known to contain significant qualities of moisture (ranging from 30 to 70% calculated on a wet basis) and consequently have a low market value. Nevertheless these coals are often used to generate electricity in the countries where the deposits are found. In conventional coal feed power stations the high moisture content in the fuel greatly affects the efficiency at which the power stations can operate and this is particularly the case when boiler plants used in those power stations are operated at atmospheric pressure.

In an effort to improve the efficiency of coal fired power stations and reduce greenhouse gas emissions, advanced power cycles fueled with lignites are currently being developed which operate at pressures higher than atmospheric and generally up to about 25 bar.

While the use of higher operating pressures with the boiler plants results in a number of thermodynamic advantages and efficiencies, the feeding of solid material into a pressurized environment introduces a number of engineering problems. The main options used for feeding high rank coals into a high pressure environment involve either lock hoppers or pumping the feed coal as a slurry in water. Both systems have inherent disadvantages. Lock hoppers are more costly and from an engineering point of view more complex. Slurry handling, while simpler and currently used in some pressurised fluidised bed combustors (PFBC) and gasification plants, causes a reduction in plant efficiency as energy is required to evaporate the extra water which is added to form the slurry. As lignites and other low rank coals already have a high moisture content, power plants using such coals already have an inherently lower potential overall efficiency. Consequently one of the minimum requirements for any solid feeding system into power stations fueled by such coals and have above atmospheric combustors is that the raw coal must be fed with minimal and preferably no added water. In fact if the feeder is able to remove water and thereby reduce the moisture content of the coal this would be an advantage.

Furthermore, the advanced combustion technologies for power stations utilise a feed in a finely divided form which for low rank coals is dried in an entrained flow dryer prior to feeding into the combustor. If a feeder were able to suitably macerate the coal then the free feed grinding requirement can be greatly reduced or possibly eliminated.

A final requirement inherent in any coal handling system for a power station is that the system be able to supply coal at a rate sufficient to meet the combustor capacity. The required supply rate for each feeder depends on the size of the boiler capacity and number of feeders but is typically in the range of 50 to 100 times per hour.

It is an object of the present invention to provide a system for supplying solid material to a pressurised vessel which is particularly suited to supplying high moisture content coal to a pressurised combustor.

Accordingly the invention provides a feeder for high moisture content carbonaceous material comprising a housing having an inlet for introducing the carbonaceous material to said housing, said housing having a converging section, a shaft extending through said housing, said shaft having one or more radially extending auger sections defining a screw flight for transporting the carbonaceous material through the housing said radially extending auger sections on said shaft extending at least to an entrance of but not through the converging section of the housing, and at least one paddle extending radially from said shaft within said converging section.

Preferably, the converging section is frusto-conicular in shape.

In a preferred form of the invention a plurality of paddles extend radially from said shaft within the converging section of the housing and are arranged within a plane perpendicular to the longitudinal axis of the shaft. The screw flight formed on the shaft for transporting the carbonaceous material along the housing is preferably formed in a helical shape and may be in the form of a single radially extending auger section extending from the inlet of the housing to the section.

In another form of the invention, the feeder may comprise a plurality of converging sections within the housing, the shaft extending through said housing and having a number of screw flighted regions comprising one or more radially extending auger sections for conveying carbonaceous material from the inlet and between the converging sections. It is preferable that each of the converging sections is provided with at least one paddle extending radially from the shaft within the converging section.

In operation of a preferred embodiment of the invention, the coal which is feeding through the inlet is transported to the entrance of the converging section of the housing by the screw flight formed on the shaft. With the mechanically applied pressure of the screw flight continually supplying carbonaceous material to the frusto-conicular section, and the physical interaction between the screw flight and the carbonaceous material in the frusto-conical section beyond the screw flight, it is believed that the shear forces generated on the carbonaceous material in the frusto-conicular section macerate the carbonaceous material as it is effectively extended through the conicular section. This maceration has the effect of reducing the particle size of the carbonaceous material as well as releasing some of the moisture bound up in the porous structure of the material. Such a maceration would not be possible if the screw flighted sections of the shaft extended through the converging section as the carbonaceous material would not be subject to the shearing effects while being extruded through the converging section. The paddle or paddles provided in the converging section encourage the carbonaceous material in the converging section to continue moving under the pressure applied by the continual supply of carbonaceous material to the entrance of the converging section by the screw flight. Hence the paddle or paddles in the converging section prevent the coal from becoming too compacted and reduce blocking in the converging section of the housing.

After the converging section of the housing, the shaft may be provided with a transport screw for discharging the carbonaceous material from the feeder. With the carbonaceous material being extended through the converging section of the housing by the mechanical pressure applied by the continual supply of carbonaceous material by the screw flight. The converging section of the housing forms an effective pressure lock against back pressure at the outlet of the feeder. This enables the invention to be particularly useful for feeding carbonaceous material from a low pressure region to a high pressure region as would be found in feeding carbonaceous material into a pressurised gasifier or combustion vessel.

In a preferred form of the invention, the transport screw may be provided on a shaft of increasing diameter towards a material discharge to provide compression of the coal. Such compression could also be provided by, for example, a variable pitch screw. The section of the housing around the transport screw may be perforated to allow moisture released by the compression of the carbonaceous material to be removed from the solid material.

In another aspect of the invention there is provided a feeder for high moisture content solid carbonaceous material comprising a housing hang an inlet for the introduction of carbonaceous material into said housing and one or more converging sections or stages through which carbonaceous material passes, a shaft extending through said housing having, one or more radially extending auger sections, said auger sections defining at least one screw flighted region extending from said inlet up to a first of said one or more converging sections or between adjacent converging sections, and at least one paddle extending generally radially from said shaft within the one or more converging sections.

Preferably, the one or more converging sections are frusto-conicular in shape.

The screw flighted region may be formed from a single radially extending auger section which is preferably formed into a helical shape around the shaft which extends at least into but not through the converging section.

The highly macerated coal typically leaves the multistage feeder in the form of a densely compressed plug of coal.

The feeder may further be provided with a transport screw extending to an outlet of the housing for transporting the carbonaceous material from the one or more converging sections, preferably from a last converging section, to the outlet. The feeder may be provided with injectors preferably for the injection of hot fluids such as saturated steam into the housing. The injectors may be provided at the exit to the converging section(s) to heat the carbonaceous material and assist in releasing the water from the carbonaceous material structure if subsequently subjected to mechanical pressure to squeeze the water from the coal.

The feeder may also be provided with a shredder following the final stage of feeding to produce fine shavings from the compressed coal plug as it is discharged from the housing. This preferred feature may be particularly useful if the carbonaceous material is to be fed directly to a pressurised entrained flow dryer prior to being fed as fuel to a pressurised gasifier or combustor.

The features objects and advantages of the present invention become more apparent from the following description of the preferred embodiment and accompanying drawings in which:

FIG. 1 is a plan view of a feeder of the invention having a single frusto-conical section,

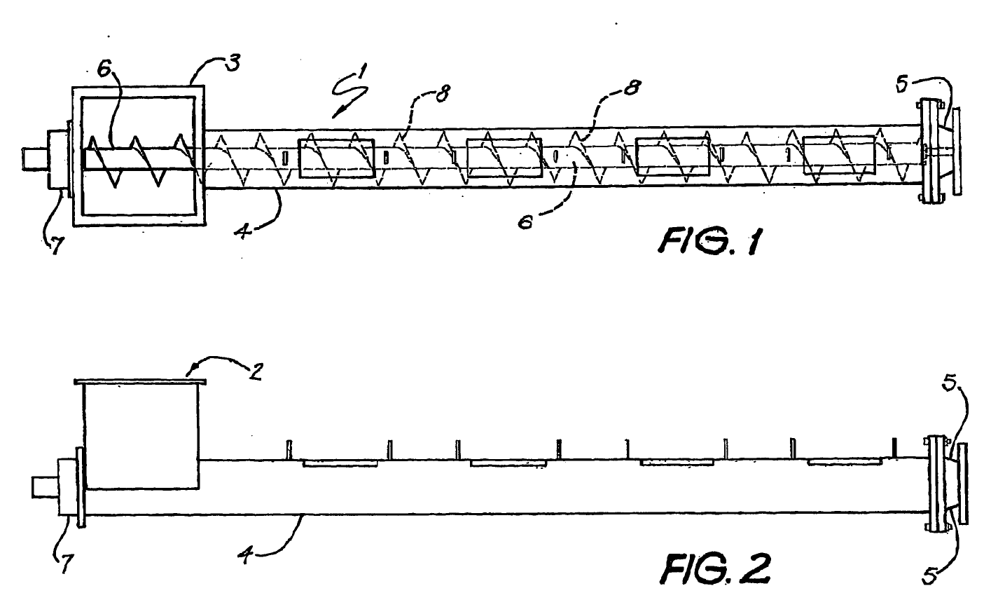

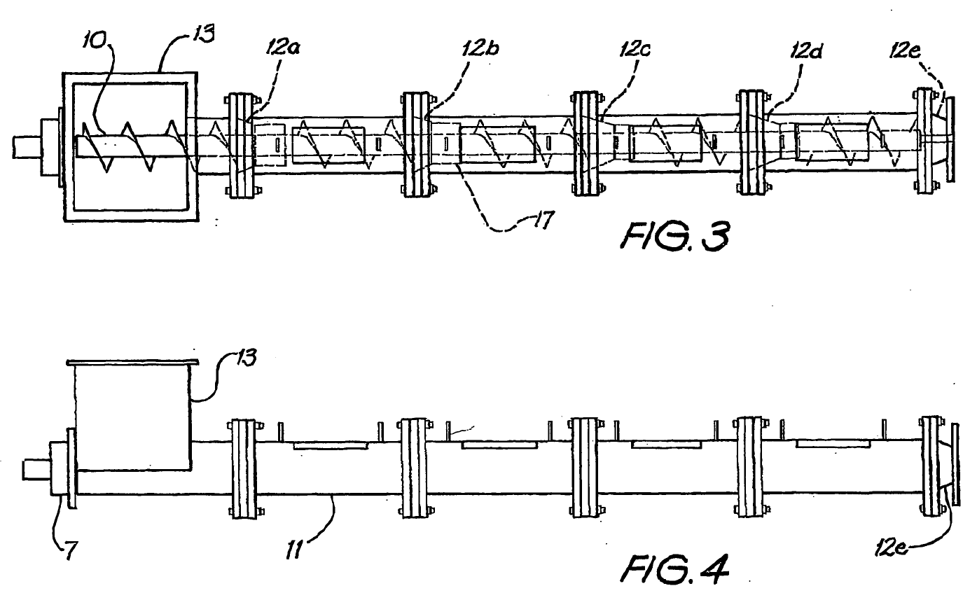

FIG. 2 is a side view of the embodiment shown in FIG. 1,

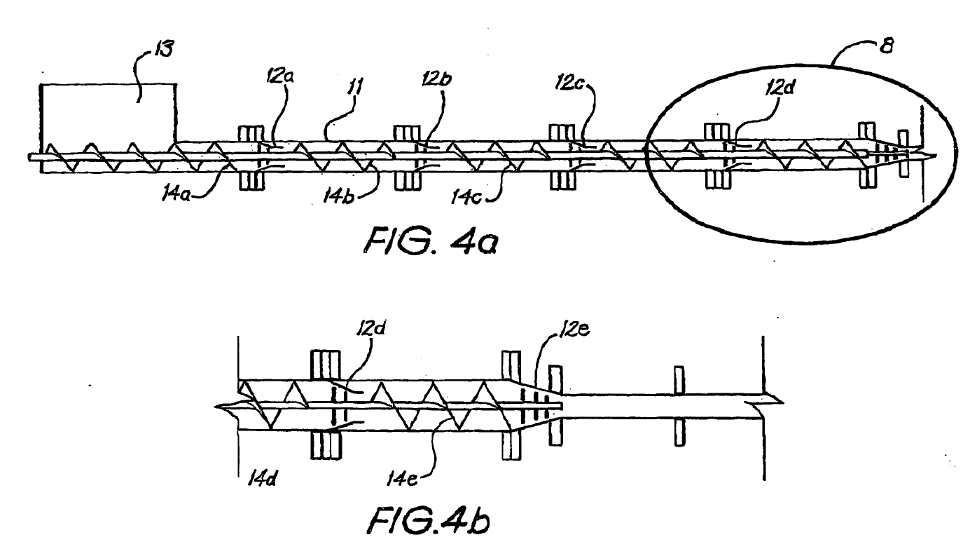

FIG. 3 is a plan view of a feeder in accordance with a second embodiment of the invention hag multiple frusto-conicular sections,

FIG. 4 is a side view of the embodiment shown in FIG. 3,

FIG. 4a is a sectional side elevation of the embodiment of FIGS. 3 and 4,

FIG. 4b is an exploded sectional view of section B of FIG. 4,

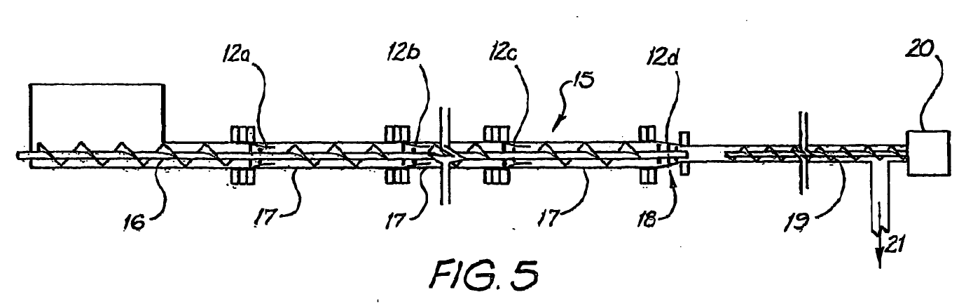

FIG. 5 is a side view of a third embodiment of the invention,

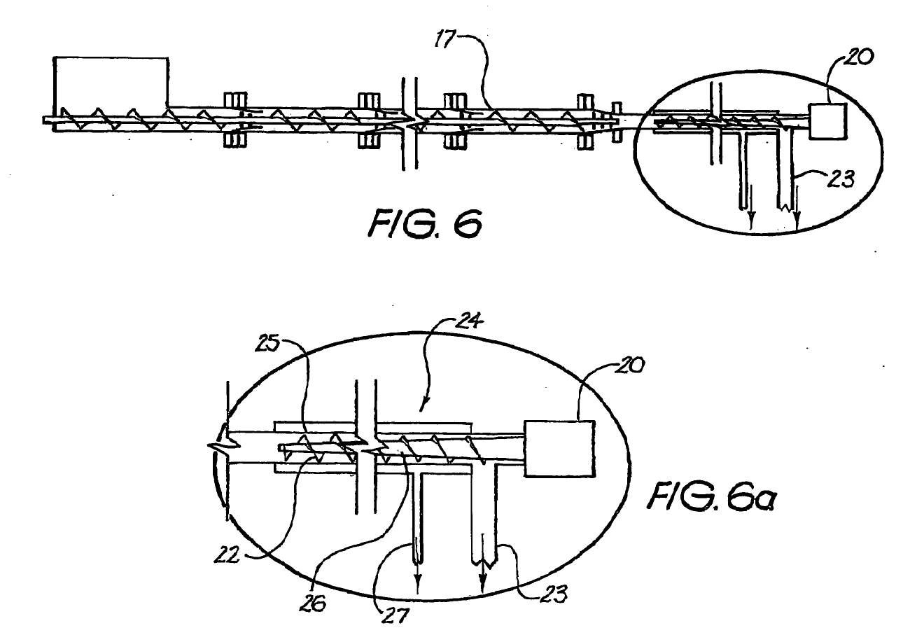

FIG. 6 is a side view of a fourth embodiment of the invention,

FIG. 6(a) is an exploded view of region A in FIG. 6,

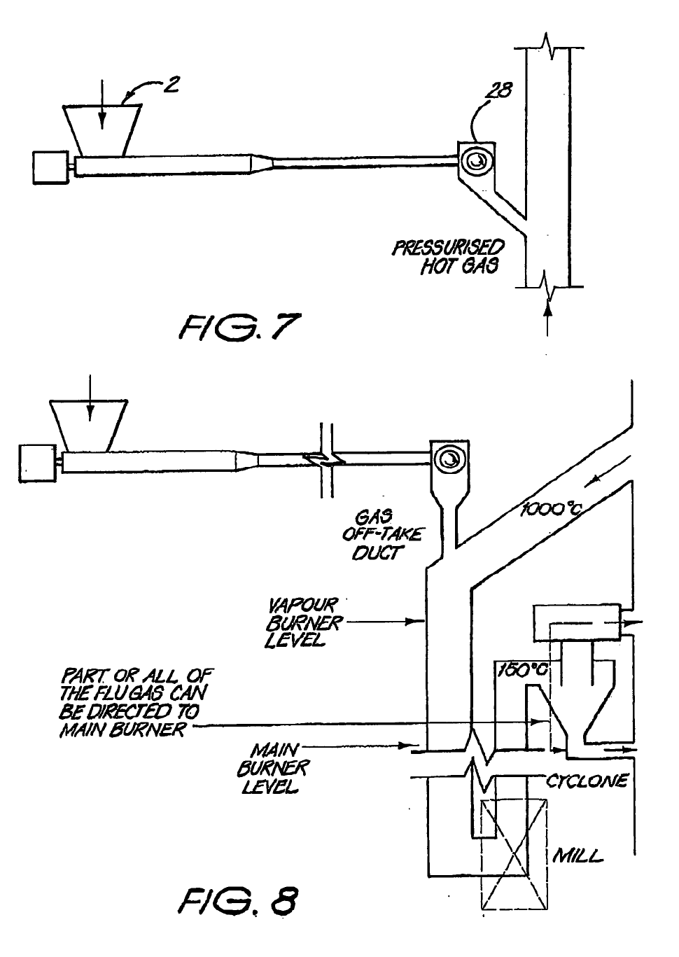

FIG. 7 is a side view of the invention coupled to a pressurised entrained flow dryer, and

FIG. 8 is a side view of an embodiment of the invention coupled to a conventional power plant.

Referring to FIG. 1, a feeder 1 having a single screw flighted section is shown. The feeder 1 includes an inlet 2 consisting of a hopper 3 feeding material into housing 4. Housing 4 has a converging frusto-conical section 5 and a longitudinal shaft 6 is provided extending through the frusto-conical section and preferably the length of the housing. The longitudinal shaft 6 is mounted on spherical roller thrust bearings 7 in housing 4 and is rotated by a drive motor (not shown).

The longitudinal shaft is provided with radially extending auger sections 8 which form a screw flighted region between the inlet and the converging frusto-conical section 5. The radially extending auger sections on the shaft 6 extend from the inlet hopper 3 at least to the entrance of but not through the frusto-conicular section 5 for transporting carbonaceous material such as low rank coals from the inlet 2 to the converging frusto-conicular section 5 where the coal is macerated. Hence the role of the auger sections is only to deliver the carbonaceous material to the frusto-conicular section 5. Once at the frusto-conicular section 5, the mechanical pressure provided by the continual supply of carbonaceous material by the auger section and the physical interaction between the back surface of the auger section and the carbonaceous material in the frusto-conical section beyond the screw flight forces the carbonaceous material through the converging frusto-conicular section. The carbonaceous material is essentially extended through the frusto-conicular section 5 by this mechanical pressure. The coal while being extruded is subject to substantial shearing by the action of the end of the screw which causes the coal beyond the screw to be macerated.

To assist in the flow of carbonaceous material through the converging frusto-conicular section 5, at least one paddle extending from the shaft in the frusto-conicular section may be provided.

It is preferable that more than one paddle is provided to assist in the flow of carbonaceous material through the frusto-conicular section and in those situations, the preferred arrangement is to position all of the paddles extending radially from the shaft in a plane perpendicular to the shaft 6. The paddles have been successfully formed from high tensile bolts which extend from the shaft with the frusto-conicular section. As the purpose of the paddles is to prevent the carbonaceous material from packing too tightly, it is preferable not to arrange the paddles in a configuration which would increase the mechanical pressure in the frusto-conicular section.

The applicants have found that when carbonaceous material is fed through a feeder as described above a plug of carbonaceous material is discharged with a constant axial velocity without any rotational component. Density measurements have indicated that the plug is highly compressed with little air voidage.

FIGS. 3 and 4, 4a and 4b show an embodiment of the invention having multiple converging frusto-conicular sections. In this embodiment, shaft 10 extends through all of the frusto-conicular sections and preferably the length of housing 11 from inlet hopper 13 to last frusto-conicular section 120 in the series of macerating sections 12a to 12c.

In each case, the auger sections 14a to 14e feed each of the respective macerating sections 12a to 12e and terminate at the entrance to those macerating sections. As with the single stage embodiment, at least one paddle is preferably provided in each of the macerating sections and if more than one paddle is provided in the macerating section, then these paddles are preferably arranged in a planar arrangement extending perpendicularly to the shaft. There may be several such planes of paddles within the macerating section as shown in FIGS. 4a, 4b, with the planes of paddles being represented by heavy black lines in the macerating sections in FIGS. 4a and 4b.

FIG. 5 shows a general configuration of a further embodiment of the invention which typically would have at least three converging frusto-conicular sections, with FIG. 5 showing four such sections 12a-12d. As with the embodiments of FIGS. 3, 4, 4a and 4b, a longitudinal shaft 16 extends through all of the frusto-conicular sections and preferably the length of the housing 15. Auger sections extend radially from the shaft to define screw flighted sections either between the inlet and the first frusto-conicular section or between respective frusto-conicular sections. The auger sections extend at least to but not through the entrance to each macerating or frusto-conicular section to enable the coal to be sheared, compacted and macerated. As the carbonaceous material depart each converging frusto-conicular section, the carbonaceous material is pushed trough the housing a short distance along an intermediate section 17 before the auger sections on the shaft receive and transport the carbonaceous material to the next converging frusto-conicular section. In this intermediate section 17 of the housing, after the frusto-conicular section where the carbonaceous material moves as a plug, injectors may be provided in those intermediate sections for the injection of hot fluids such as saturated steam to aid in the de-watering of the carbonaceous material structure.

As with other embodiments, at least one paddle may be provided in the, converging frusto-conicular section to loosen the carbonaceous material plug and reduce the packing of the carbonaceous material as it progresses rough this section.

Once the carbonaceous material has passed through the last of the macerating sections 18 of the feeder, to reduce the power consumption resulting from further housing of the coal plugs due to the resistance caused by the outlet pipe, the material way then be received by a transport screw conveyor 19 which may be on the same shaft or can be a separate shaft powered by a separate drive 20. The transport screw conveyor 19 transports the carbonaceous material from the housing to a coal discharge 21.

FIGS. 6 and 6a show an arrangement of the transport screw conveyor 19 shown in FIG. 5 which is designed to reduce the moisture content of the coal. This embodiment provides a continuous dewatering of the coal using the principle of the Mechanical Thermal Expression process (eg. Ref. Berger S, Bergins C, Strauss K, Bielfeldt F, Elsen R, Erken M, Mechanical/Thermal Dewatering of Coal VGB Power Tech 2/99 44-49). In this arrangement the diameter of the shaft 26 of the transport screw 22 gradually increases towards the material discharge 23. A section of the housing wall is replaced with a filter screen 25 and housing 24 around filter screen 25 is enlarged to encompass the screen and provide a flow path between the housing and the screen for the moisture passing from the carbonaceous material through the screen. As a result of the gradually increasing diameter of the transport screw shaft 26, the carbonaceous material being transported by the transport screw 22 is compressed against screen 25 causing a physical pressing of water from the carbonaceous material. This water then flows from a moisture discharge 27 in housing 24 while the carbonaceous material continues to the discharge 23 from the feeder.

As stated earlier, density measurements on the plug exiting the converging frusto-conicular section of the feeder indicate that there is little air voidage in the plug. In combination with the moisture in the low rank coals, the movement of the plug through the housing provides an effective seal to the back pressure which is experienced when feeding into a high pressure environment. This feature enables the feeder of the invention to be well suited to feeding carbonaceous material such as low rate coals directly from an atmospheric environment into a pressurised vessel. In addition to providing an effective seal the invention is also able to provide a high degree of maceration of the low rank coals thereby eliminating or at least greatly reducing the grinding duty on the coal prior to feeding into a combustor.

The applicants have found that typically with a minimum of three stages, lumpy brown coal can be reduced in the feeder to a product having a mean particle size typically in the range of 20 to 40 microns. The coal which is discharged from the last converging frusto-conicular section is in the form of a densely compacted plug. In the embodiments of FIGS. 7 and 8, in which the coal is dried in an entrained flow drier, it is proposed that the feeder of the invention be provided with a shredder 28 to out the coal plug into fine shavings sufficiently small in thickness to enable them to dry while being transported along the duct by an initially hot gas stream.

Depending on the moisture content of the carbonaceous material leaving the feeder, the material may be discharged into a pressurised entrained flow dryer (FIG. 7) for moisture removal prior to feeding into a pressurised reactor such as a gasifier or combustor. A finer application is that the carbonaceous material can be fed directly into a boiler in a conventional power plant (FIG. 8) as a substitute to a conventional milling drying system as used in high moisture lignite fuelled power station boilers.

Since modifications within the spirit and scope of the invention may be readily effected by persons skilled in the art, it is to be understood that the invention is not limited to the particular embodiment described, by way of example, hereinabove.

1. A feeder for high moisture content carbonaceous material comprising a housing having an inlet for introducing the carbonaceous material to said housing, said housing having a converging section, a shaft extending through said housing, said shaft having one or more radially extending auger sections defining a screw flight for transporting the carbonaceous material through the housing said radially extending auger sections on said shaft extending at least to an entrance of but not through the converging section of the housing, and at least one paddle extending radially from said shaft within said converging section.

2. A feeder as claimed in claim 1 wherein the converging section is essentially frusto-conicular in shape.

3. A feeder as claimed in claim 1 further comprising a plurality of paddles extending radially from said shaft within the converging section of the housing, said paddles being arranged with a plan that is perpendicular to a longitudinal axis of the shaft.

4. A feeder as claimed in claim 1 wherein the screw flight for transporting the carbonaceous material through the housing is of helical shape.

5. A feeder as claimed in claim 4 wherein the screw flight comprises a single, radially extending auger section extending from the inlet of the housing to the converging section.

6. A feeder as claimed in claim 1 further comprising a plurality of converging sections within the housing, the shaft extending through said housing and having a number of screw flighted regions comprising one or more radially extending auger sections for conveying carbonaceous material from inlet and between the converging sections.

7. A feeder is claimed in claim 6 wherein each of the converging sections is provided with at least one paddle extending generally radially from the shaft within the converging sections.

8. A feeder as claimed in claim 1 further comprising a transport screw for discharging the carbonaceous material from the feeder, said transport screw being located downstream of the converging section or sections.

9. A feeder as claimed in claim 8 wherein said transport screw is provided on a shaft of increasing diameter towards a material discharge to provide compression of the carbonaceous material.

10. A feeder as claimed in claim 8 wherein said transport screw comprises a variable pitch screw for compressing the carbonaceous material.

11. A feeder as claimed in claim 8 wherein the transport screw is at least partly surrounded by a perforated or foraminate section to allow moisture to be removed from the carbonaceous material.

12. A feeder for high moisture content solid carbonaceous material comprising a housing having an inlet for introduction of carbonaceous material into said housing and one or more converging section or stages through which carbonaceous material passes, a shaft extending through said housing having one or more radially extending auger sections, said auger sections defining at least one screw flighted region extending from said inlet up to a first of said one or more converging sections or between adjacent converging sections, and at least one paddle extending radially from said shaft within the one or more converging sections.

13. A feeder as claimed in claim 12 wherein the converging sections are frusto-conicular in shape.

14. A feeder as claimed in claim 12 further comprising a transport screw extending to an outlet of the housing for transporting the carbonaceous material from a last of the converging sections to the outlet.

15. A feeder as claimed in claim 12 further comprising one or more injectors for injecting hot fluid into the housing.

16. A feeder as claimed in claim 15 wherein the hot fluid is saturated steam.

17. A feeder as claimed in claim 12 wherein the carbonaceous material exits the feeder as a dense plug and the feeder further comprises a shredder to produce fine shavings from the dense plug as it leaves the housing.

18. (canceled)
